(19) United States
(12) Patent Application Publication
(10) Pub. No.: US 2020/0274729 A1
(43) Pub. Date: Aug. 27, 2020

(54) IN-VEHICLE COMMUNICATION DEVICE, IN-VEHICLE COMMUNICATION SYSTEM AND IN-VEHICLE COMMUNICATION METHOD

(71) Applicants: National University Corporation Tokai National Higher Education and Research System, Nagoya-shi, Aichi (JP); AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Hiroaki Takada, Nagoya-shi, Aichi (JP); Ryo Kurachi, Nagoya-shi, Aichi (JP); Hiroshi Ueda, Yokkaichi-shi, Mie (JP)

(21) Appl. No.: 16/756,997

(22) PCT Filed: Oct. 15, 2018
(86) PCT No.: PCT/JP2018/038254

§ 371 Date: Apr. 17, 2020

(30) Foreign Application Priority Data
Oct. 20, 2017 (JP) 2017-204025

(51) Int. Cl. H04L 12/40; H04W 4/48

(52) U.S. Cl. CPC H04L 12/40; H04L 2012/40273; H04L 2012/40215; H04W 4/48

(57) ABSTRACT

An in-vehicle communication device, an in-vehicle communication system and in-vehicle communication method which make it possible to detect a high-risk message transmitted into the in-vehicle communication system by a simple configuration is provided. This in-vehicle communication device is provided with a communication unit bus-connected to an in-vehicle communication bus, and is provides with a communication control unit that controls transmission and reception of messages including object messages to be counted by the communication unit, and causes a specified message including authentication information to be intermittently transmitted from the communication unit, wherein the communication control unit includes, in the specified message to be transmitted at a first time point, the number of times of transmission of the object messages transmitted between the transmission of the most recent specified message transmitted before the first time point and the first time point.

### CROSS-REFERENCE TO RELATED APPLICATIONS

This application is the U.S. national stage of PCT/JP2018/038254 filed on Oct. 15, 2018, which claims priority of Japanese Patent Application No. JP 2017-204025 filed on Oct. 20, 2017, the contents of which are incorporated herein by reference.

### TECHNICAL FIELD

The present disclosure relates to an in-vehicle communication device, an in-vehicle communication system and an in-vehicle communication method.

### BACKGROUND

In order to protect an in-vehicle communication system from an attack, a technique has been proposed to provide messages exchanged based on the Controller Area Network (CAN) protocol used in the in-vehicle communication system with authentication information in, for example, AUTomotive Open System Architecture (AUTOSAR®) that advocates a platform common to the software implemented in the in-vehicle communication device.

Non-patent Document 1: AUTOSAR, “Specification of Module Secure Onboard Communication”, [online], Nov. 30, 2016, Classic Platform Release 4.3.0, Internet <https://www.autosar.org/fileadmin/files/standards/classic/4-3/software-architecture/safety-and-security/standard/AUTOSAR_SWS_SecureOnboardCommunication.pdf>

Widely used in a field of vehicle control is a communication system configured to allow control devices such as electronic control units (ECUs) for electrically controlling multiple parts placed in a vehicle to communicate with each other and to transmit and receive information to each other for cooperatively performing various processing. Meanwhile, it has been pointed out that there is a risk of making the vehicle unsteerable when unauthorized information is sent to such a communication system by an attacker.

As disclosed in the non-patent document 1, each of the information to be transmitted and received in the in-vehicle communication system is assigned with authentication information which is used to verify the safety of the information at the reception side so as to remove dangerous information, enabling system protection. It is, however, difficult in terms of implementation to provide all of the information with authentication information in view of the communication load and processing load.

It is an object of the present disclosure to provide an in-vehicle communication device, an in-vehicle communication system and an in-vehicle communication method that are capable of detecting with a simple configuration a message with a high risk that is transmitted to the in-vehicle communication system.

### SUMMARY

An in-vehicle communication device according to an aspect of the present disclosure, includes a communication unit being bus-connected to an in-vehicle communication bus. The in-vehicle communication device further comprises a communication control unit that controls transmission and reception of a message including a target message to be counted, by the communication unit, and intermittently transmits a specific message including authentication information from the communication unit, wherein the communication control unit is adapted to include in the specific message to be transmitted at a first time point the number of transmissions of the target messages that have been transmitted during a period from transmission of a latest specific message transmitted before the first time point to the first time point.

An in-vehicle communication system according to an aspect of the present disclosure, comprises a plurality of in-vehicle communication devices each including a communication unit being bus-connected to an in-vehicle communication bus. In the in-vehicle communication system, a part of the plurality of in-vehicle communication devices includes a communication control unit that controls transmission and reception of a message including a target message to be counted, by the communication unit, and intermittently transmits a specific message including authentication information from the communication unit, wherein the communication control unit is adapted to include in the specific message to be transmitted at a first time point the number of transmissions of the target messages that have been transmitted during a period from transmission of a latest specific message transmitted before the first time point to the first time point. A part or all of the plurality of in-vehicle communication devices include: a storage unit that stores the number of receptions of the target messages; an update unit that updates the number of receptions stored in the storage unit if the message received by the communication unit is the target message; and an abnormality detection unit that, if the message received by the communication unit is the specific message, reads out the number of receptions stored in the storage unit, determines whether or not the number of receptions is coincident with the number of transmissions of the target messages included in the specific message, and detects an abnormality if the number of receptions and the number of transmissions are not coincident with each other.

An in-vehicle communication method according to an aspect of the present disclosure, includes transmitting and receiving a message between a plurality of in-vehicle communication devices each including a communication unit being bus-connected to an in-vehicle communication bus. The in-vehicle communication method comprises: by a part of the plurality of in-vehicle communication devices, transmitting a plurality of times a message including a target message to be counted from the communication unit; intermittently transmitting a specific message including authentication information from the communication unit; and including in the specific message to be transmitted at a first time point the number of transmissions of the target messages that have been transmitted during a period from transmission of the latest specific message transmitted before the first time point to the first time point.

The in-vehicle communication method further comprises: by a part or all of the plurality of in-vehicle communication devices; updating the number of receptions stored in a storage unit if the message received by the communication unit is the target message; reading out the number of receptions stored in the storage unit if the message received by the communication unit is the specific message; determining whether or not the number of receptions is coincident with the number of transmissions of the target messages included in the specific message received; and detecting an abnormality if the number of receptions is not coincident with the number of transmissions.

### BRIEF DESCRIPTION OF THE DRAWINGS

FIG. 1 is a block diagram illustrating the configuration of an in-vehicle communication system according to an embodiment of the present disclosure.

FIG. 2 is a block diagram illustrating the internal configuration of an ECU and a GW.

FIG. 3 is a flowchart illustrating one example of message transmission processing performed by the ECU.

FIG. 4A illustrates the outline of message processing performed in a communication unit.

FIG. 4B illustrates the outline of the message processing in the communication unit.

FIG. 4C illustrates the outline of the message processing in the communication unit.

FIG. 4D illustrates the outline of the message processing in the communication unit.

FIG. 5 is a schematic view illustrating messages transmitted to a communication bus.

FIG. 6 is a flowchart illustrating one example of message reception processing performed by the GW that detects an abnormality.

FIG. 7 illustrates the outline of the processing at the GW.

FIG. 8 illustrates the update of the number of receptions in a third table.

FIG. 9 is a flowchart of one example of a processing procedure relating to abnormality detection.

FIG. 10 is a flowchart illustrating one example of the processing procedure in the ECU after abnormality detection.

### DETAILED DESCRIPTION OF PREFERRED EMBODIMENTS

Embodiments of the present disclosure are first listed.

Moreover, at least parts of the embodiments that will be described below may arbitrarily be combined.

An in-vehicle communication device according to an aspect of the present disclosure, includes a communication unit being bus-connected to an in-vehicle communication bus. The in-vehicle communication device further comprises a communication control unit that controls transmission and reception of a message including a target message to be counted, by the communication unit, and intermittently transmits a specific message including authentication information from the communication unit, wherein the communication control unit is adapted to include in the specific message to be transmitted at a first time point the number of transmissions of the target messages that have been transmitted during a period from transmission of a latest specific message transmitted before the first time point to the first time point.

In the in-vehicle communication device according to an aspect of the present disclosure, the in-vehicle communication bus is a CAN bus, and the specific message is a keep alive message periodically transmitted, and in a payload of the keep alive message, the authentication information and the number of transmissions are included, and the keep alive message is provided with an CANID having a priority over another communication device upon arbitration of the CAN bus.

In the in-vehicle communication device according to an aspect of the present disclosure, the specific message includes information indicating an error state of the in-vehicle communication device.

An in-vehicle communication device according to an aspect of the present disclosure, includes a communication unit being bus-connected to an in-vehicle communication bus, and transmitting and receiving a message by the communication unit. The in-vehicle communication device comprises: a storage unit that stores the number of receptions of target messages to be counted; an update unit that updates the number of receptions stored in the storage unit if the message received by the communication unit is one of the target messages; and an abnormality detection unit that, if the message received by the communication unit is a specific message, reads out the number of receptions stored in the storage unit, determines whether or not the number of receptions is coincident with the number of transmissions of the target messages included in the specific message, and detects an abnormality if it is determined that the number of receptions and the number of transmissions are not coincident with each other.

In the in-vehicle communication device according to an aspect of the present disclosure, the abnormality detection unit further comprises an authentication processing unit that executes authentication processing based on authentication information included in the specific message, and detects normality if it is determined that authentication by the authentication processing unit is successful, and the number of receptions is coincident with the number of transmissions.

An in-vehicle communication system according to an aspect of the present disclosure, comprises a plurality of in-vehicle communication devices each including a communication unit being bus-connected to an in-vehicle communication bus. In the in-vehicle communication system, a part of the plurality of in-vehicle communication devices includes a communication control unit that controls transmission and reception of a message including a target message to be counted, by the communication unit, and intermittently transmits a specific message including authentication information from the communication unit, wherein the communication control unit is adapted to include in the specific message to be transmitted at a first time point the number of transmissions of the target messages that have been transmitted during a period from transmission of a latest specific message transmitted before the first time point to the first time point. A part or all of the plurality of in-vehicle communication devices include: a storage unit that stores the number of receptions of the target messages; an update unit that updates the number of receptions stored in the storage unit if the message received by the communication unit is the target message; and an abnormality detection unit that, if the message received by the communication unit is the specific message, reads out the number of receptions stored in the storage unit, determines whether or not the number of receptions is coincident with the number of transmissions of the target messages included in the specific message, and detects an abnormality if the number of receptions and the number of transmissions are not coincident with each other.

An in-vehicle communication method according to an aspect of the present disclosure, includes transmitting and receiving a message between a plurality of in-vehicle communication devices each including a communication unit being bus-connected to an in-vehicle communication bus. The in-vehicle communication method comprises: by a part of the plurality of in-vehicle communication devices, transmitting a plurality of times a message including a target message to be counted from the communication unit; intermittently transmitting a specific message including authentication information from the communication unit; and including in the specific message to be transmitted at a first time point the number of transmissions of the target messages that have been transmitted during a period from transmission of the latest specific message transmitted before the first time point to the first time point. The in-vehicle communication method further comprises: by a part or all of the plurality of in-vehicle communication devices; updating the number of receptions stored in a storage unit if the message received by the communication unit is the target message; reading out the number of receptions stored in the storage unit if the message received by the communication unit is the specific message; determining whether or not the number of receptions is coincident with the number of transmissions of the target messages included in the specific message received; and detecting an abnormality if the number of receptions is not coincident with the number of transmissions.

In one aspect of the present disclosure, the specific message intermittently transmitted from the in-vehicle communication device includes the number of transmissions of the target messages to be counted out of the messages transmitted by the in-vehicle communication device itself multiple times. Thus, another in-vehicle communication device that is bus-connected to the in-vehicle communication bus to thereby receive a message can compare the number of transmissions included in the specific message and the number of receptions of the target messages actually received from the in-vehicle communication bus, and detects an abnormality depending on whether or not the number of transmissions and the number of receptions are coincident with each other.

In one aspect of the present disclosure, the specific message is adapted to include the authentication information, which enables the execution of the authentication processing using a key corresponding to the authentication information. This ensures the reliability of the number of transmissions included in the specific message. Even if a spoof message is transmitted for the specific message, processing can be executed by removing the spoof message.

In one aspect of the present disclosure, the error state of the device itself is included in a keep alive message and transmitted. Even in the communication system complying with the CAN, not the CAN flexible data-rate (FD), an error state such as an error active, an error passive, etc. can be confirmed by another device.

It is noted that the present application may be achieved as an in-vehicle communication device having such characteristic components as well as a computer program causing a computer to execute such characteristic steps and a storage medium storing the program. The present application may be achieved as a semiconductor integrated circuit implementing a part or all of the components of the in-vehicle communication system or as another system including an in-vehicle communication system using the in-vehicle communication device.

### Effects of the Disclosure

According to the above description, it is possible to remove a message with a high risk sent out to the in-vehicle communication system with a simple configuration.

Examples of the in-vehicle communication device according to the embodiments of the present disclosure will be described below in detail with reference to the drawings. It is to be understood that the inventions herein disclosed are illustrative in all respects and not restrictive, and all changes that fall within the meanings and the bounds of the claims, or equivalence of such meanings and bounds are intended to be embraced by the claims.

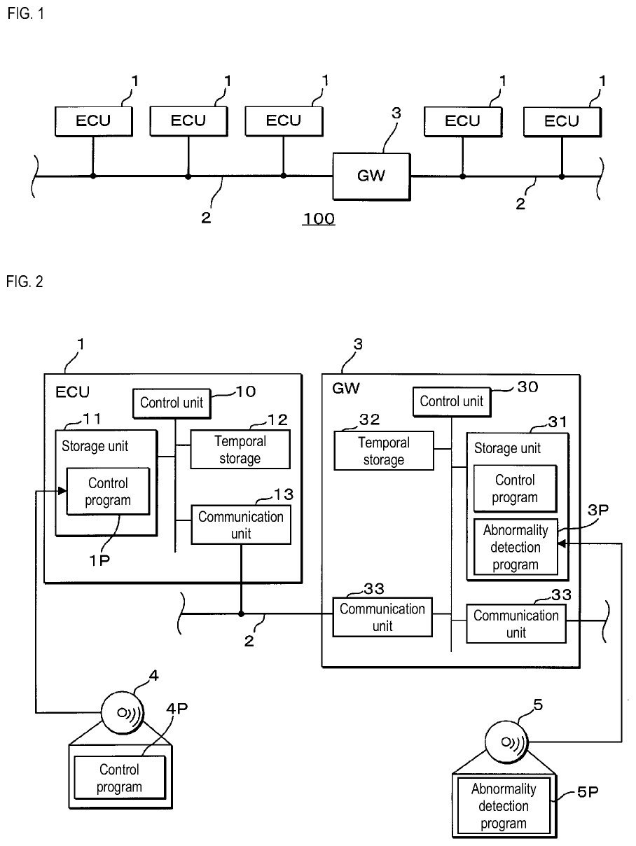

FIG. 1 is a block diagram illustrating the configuration of an in-vehicle communication system 100 according to an embodiment. The in-vehicle communication system 100 includes multiple communication buses 2 that are placed in a vehicle, multiple ECUs 1 that are placed in various parts of the vehicle and are connected to any of the multiple communication buses 2, and a GW3 that performs relay processing between the different communication buses 2.

The ECU 1 is connected to parts such as an in-vehicle switch, a sensor, an actuator or the like (not illustrated), and sends out information obtained from the switch or the sensor to the communication bus 2 as well as controls the operation of the actuator or the like based on the information received through the communication bus 2. The GW3 receives all the messages transmitted from the multiple ECUs 1 through the different communication buses 2 and relays each of the messages to another communication bus 2 as necessary based on a table storing the information indicating whether relaying to another communication bus 2 is necessary or not. It is noted that in the embodiment that will be described below, the communication bus 2 is a CAN bus, and thus the ECUs 1 and the GW3 each transmit and receive multiple messages multiple times in compliance with the CAN protocol.

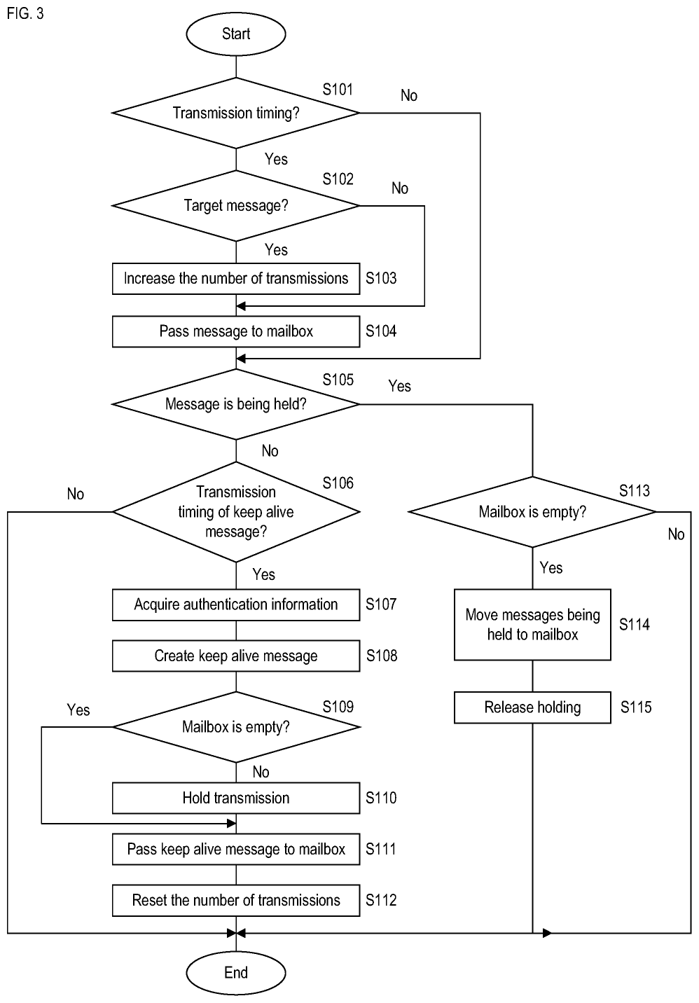

FIG. 2 is a block diagram illustrating the internal configuration of the ECUs 1 and the GW3. The ECU 1 includes a control unit 10, a storage unit 11, a temporary storage unit 12 and a communication unit 13. The control unit 10 includes an arithmetic processing device such as a central processing unit (CPU), a micro processing unit (MPU) or the like. The control unit 10 includes an input-output interface, and is connected to equipment such as a switch, a sensor, etc. thorough this input-output interface. The control unit 10 reads out and executes a control program 1P stored in the storage unit 11 to thereby perform arithmetic processing and control processing for controlling each component and equipment. The control unit 10, for example, executes the processing complying with the CAN protocol included in the control program to function as a CAN-compatible network controller (communication control unit) in cooperation with the hardware provided in the communication unit 13.

The storage unit 11 includes a nonvolatile memory such as a flash memory, etc. and stores in advance various information to be referred to when processing is performed other than the control program 1P to be executed by the control unit 10. It is noted that a part of the control program 1P may be stored in a mask read only memory (ROM) or the like contained in the control unit 10. The temporary storage unit 12 includes a volatile memory such as a dynamic random access memory (DRAM) or the like and temporarily stores information generated by the processing performed by the control unit 10. The control program 1P may be obtained by the control unit 10 reading out a control program 4P stored in a recording medium 4 and copying it onto the storage unit 11.

The communication unit 13 achieves transmission and reception of information through the communication bus 2 using a CAN controller and a CAN transceiver. The communication unit 13 receives an instruction from the control unit 10 and transmits CAN messages that have been created and stored in a mailbox contained in the CAN controller to the communication bus 2 one after another in cooperation with the control unit 10. Furthermore, if receiving a CAN message transmitted from another equipment through the communication bus 2, the communication unit 13 temporarily stores the CAN message in the mailbox contained in the CAN controller and passes the information included in the message to the control unit 10.

The GW3 includes a control unit 30, a storage unit 31, a temporary storage unit 32 and multiple communication units 33. The control unit 30 includes an arithmetic processing unit such as a CPU, an MPU or the like. The control unit 30 reads out and executes a control program and an abnormality detection program 3P that are stored in the storage unit 31 to thereby perform arithmetic processing and control processing for controlling each of the components. For example, by the control program, the control unit 30 functions as a CAN-compatible network controller in cooperation with the hardware provided in the communication unit 33. Furthermore, the control unit 30 executes abnormality detection processing, which will be described later, by the abnormality detection program 3P.

The storage unit 31 includes a nonvolatile memory such as a flash memory or the like, and stores in advance various information to be referred to when processing is performed, such as a relay table or the like in addition to the control program and the abnormality detection program 3P that are to be executed by the control unit 30. In the GW 3 as well, the control program and the abnormality detection program 3P may be stored in a mask ROM contained in the control unit 30. The temporary storage unit 32 includes a volatile memory such as a DRAM or the like and temporarily stores information generated by the processing performed by the control unit 30. The abnormality detection program 3P may be obtained by the control unit 30 reading out an abnormality detection program 5P stored in a recording medium 5 and copying it onto the storage unit 31.

Each of the multiple communication units 33 achieves transmission and reception of information through the communication bus 2 using a CAN controller and a CAN transceiver. If receiving a CAN message transmitted from another equipment through the communication bus 2, the communication unit 33 temporarily stores the CAN message in the mailbox contained in the CAN controller and notifies the reception to the control unit 30 as well as passes the information included in the message to the control unit 10 as necessary. Moreover, the communication unit 33 receives an instruction from the control unit 30 and sends out a CAN message that has been stored in the mailbox contained in the CAN controller to the communication bus 2.

In the in-vehicle communication system 100 thus configured, the control unit 10 of each of the ECUs 1 stores information from each equipment (in-vehicle switch, sensor, or the like) obtained from the device of its own in the payload of the CAN message and transmits the information to the connected communication bus 2 from the communication unit 13. It is noted that the control unit 10 transmits these CAN messages when periodically obtaining information from each equipment or at a timing when an event for the switch occurs. The control unit 10 instructs the communication unit 13 to transmit a keep alive message (defined as CAN network management protocol data unit in AUTOSAR) at a period equal to or longer than these transmission periods.

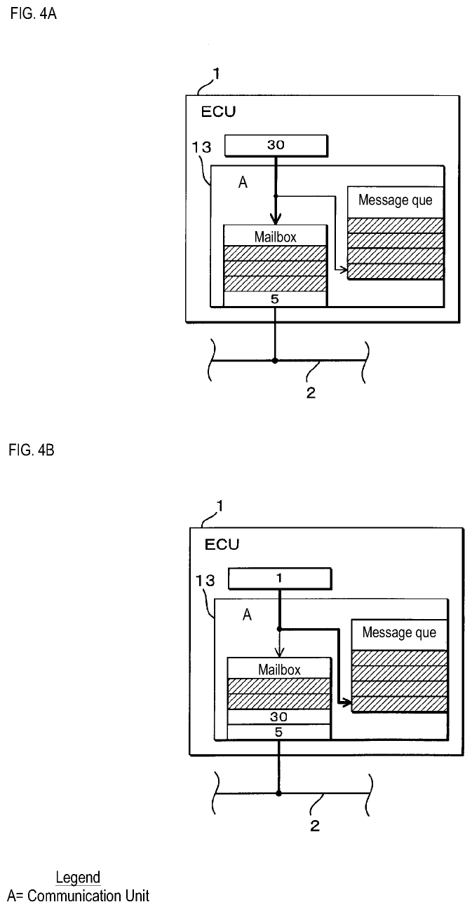

FIG. 3 is a flowchart illustrating one example of message transmission processing by the ECU 1. The control unit 10 functions as a communication processing unit to repeatedly execute the processing of the flowchart illustrated in FIG. 3 during an active state of the device of its own.

The control unit 10 determines whether or not a transmission timing of a message other than a keep alive message is reached (step S101). The transmission timing of a message other than the keep alive message is defined for each message (CANID). The transmission timing may be every preset time such as 10 milliseconds or the like, or may depend on an event such as the occurrence of interruption or the like.

If determining that the transmission timing is reached at step S101 (S101: YES), the control unit 10 determines whether or not the message to be transmitted is a target message to be counted (to-be-monitored message) (step S102). If determining that the message to be transmitted is the target message at step S102 (S102: YES), the control unit 10 increases the number of transmissions stored in the temporary storage unit 12 (step S103). Whether it is the target message or not is preset in view of the importance of the message and the risk to the vehicle if an unauthorized message is sent out in the in-vehicle communication system 100, and is stored in each of the ECU 1. If determining that the message to be transmitted is not the target message at step S102 (S102: NO), the control unit 10 advances the processing to step S104 without any change.

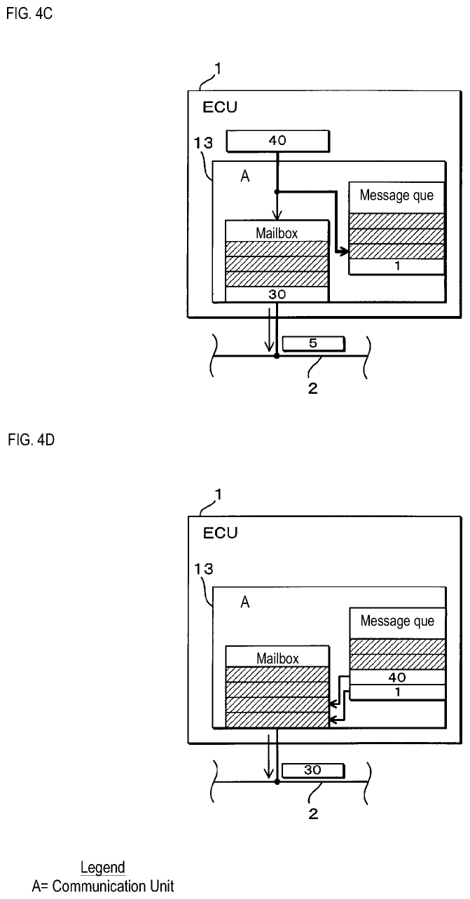

Next, the control unit 10 passes the message (data) to be transmitted to the mailbox of the communication unit 13 (step S104). Here, in the mailbox of the communication unit 13, the destination to which the message is passed is switched depending on the cases of a hold state where a message is held in order to transmit a keep alive message and another state (normal state). In the normal state, messages are sequentially stored in the mailbox as they are while in the hold state, messages are sequentially saved in a hold message queue (see FIGS. 4A to 4D). It is noted that the mailbox and the hold message queue are not necessarily configured to be substantially separate memories. They can be discriminated from each other by managing addresses in a storage medium used as a mailbox and a hold message queue.

If determining that the transmission timing is not reached at step S101 (S101: NO), the control unit 10 advances the processing to step S105.

The control unit 10 determines whether a message is being held in the mailbox (hereinafter referred to as a hold state)(step S105). If determining that it is not in the hold state (S105: NO), the control unit 10 determines whether or not transmission timing of a keep alive message is reached (step S106). In the present embodiment, the transmission timing of a keep alive message is periodic, i.e., every preset time period such as 500 milliseconds or the like.

If determining that the transmission timing is reached at step S106 (S106: YES), the control unit 10 generates authentication information (MAC: message authentication code) by a predetermined algorithm, or reads out and acquires authentication information that has been stored (step S107). The control unit 10 creates a keep alive message including, in the payload, the acquired authentication information and the number of transmissions that has been stored in the temporary storage unit 12 (step S108).

For the keep alive message created at step S108, out of 8 bytes defined as a payload in the CAN, the third byte (byte 2) to the eighth byte (byte 7) are further defined as user data (AUTOSAR (registered trademark) CAN network management). The user data section is used for authentication information and the number of transmissions. The number of bits used for the authentication information and that used for the number of transmissions out of 6 bytes may be set in view of the degree of security for the authentication information. The keep alive message in the present embodiment is set to have a CANID with a higher priority to be prioritized upon arbitration between the keep alive message and a message transmitted from another equipment such that it can surely be transmitted at the earliest possible opportunity when being sent out from the communication unit 13 to the communication bus 2.

The control unit 10 determines whether or not the mailbox is empty (the number of waiting messages is zero) with reference to the mailbox of the communication unit 13 (step S109). If determining that the mailbox is empty (S109: YES), the control unit 10 passes the created keep alive message to the mailbox of the communication unit 13 (step S111), resets the number of transmissions stored in the temporary storage unit 12 (step S112) and ends the processing.

If determining that the mailbox is not empty (S109: NO), the control unit 10 holds the transmission of messages from the mailbox of the communication unit 13 and changes the state to the hold state (step S110), passes the keep alive message to the mailbox (S111), resets the number of transmissions (S112) and ends the processing.

If determining that the mailbox is empty at step S109 (S109: YES), the keep alive message is stored at the head of the mailbox while the mailbox of the communication unit 13 remains in the normal state, and is sent out to the communication bus 2 as soon as the communication bus 2 becomes available. If determining that the mailbox is not empty at step S109 (S109: NO), the mailbox of the communication unit 13 is changed to be in the hold state, and the keep alive message is saved at the head of the hold message queue and is in wait.

If determining that it is not in the hold state (S105: NO), and the transmission timing is not reached (S106: NO), the control unit 10 ends the processing as it is. Here, the control unit 10 starts the processing from step S101 again to pass a new message from the communication unit 13 to the mailbox.

The messages passed to the communication unit 13 during the hold state are saved in the hold message queue while the messages that have already been stored in the mailbox before the keep alive message are sequentially sent out as soon as the communication bus 2 becomes available. If determining that it is in the hold state at step S105 (S105: YES), the control unit 10 determines whether or not the mailbox is empty with reference to the number of messages in the mailbox (step S113).

If determining that the mailbox is empty (S113: YES), the control unit 10 moves the messages being held that has been saved in the hold message queue to the mailbox (step S114), releases the holding (step S115) and ends the processing. Here, the keep alive message has been saved at the head of the hold message queue, and thus the keep alive message is stored at the head of the mailbox and sent out to the communication bus 2. After the hold message queue becomes empty, the control unit 10 starts the processing from step S101 again and continuously performs the processing of sequentially passing messages to the mailbox, etc.

If determining that the mailbox is not empty (S113: NO), the control unit 10 ends the processing as it is. Here, the control unit 10 starts the processing from step S101 again. A new message and a keep alive message are saved in the hold message queue until the mailbox becomes empty while messages in the mailbox are sequentially sent out to the communication bus 2 as soon as the communication bus 2 becomes available.

The communication unit 13 functions as a network controller to thereby create a CAN message from the data passed from the control unit 10 and store the message at positions in the memory that correspond to the mailbox and the hold message queue. Furthermore, the communication unit 13 stores the position (head or tail end) of the CAN message stored in the memory, and functions as a network controller to read out the messages from the head of the mailbox in sequence and to send them out to the communication bus 2 from the CAN transceiver.

The communication unit 13 functions as a network controller to continuously store messages and to send them out from the CAN transceiver during execution of the processing of the flowchart illustrated in FIG. 3 by the control unit 10.

FIGS. 4A, 4B, 4C and 4D illustrate the outline of message processing in the communication unit 13. FIGS. 4A to 4D illustrate the states of messages in the communication unit 13 that change with time. The mailbox and the hold message queue are conceptually separated into two and represented by rectangular boxes in which respective messages are stored. It is noted that the available space of the mailbox or the queue is represented by hatching.

The state illustrated in FIG. 4A corresponds to a transmission timing of a message before a transmission timing of a keep alive message. The message passed to the mailbox in FIG. 4A is a message with the CANID of “30.” In FIG. 4A, it is not in the hold state, and thus the message passed at step S104 is stored in the mailbox. Since a message with the CANID of “5” has already been waiting, the message with the CANID of “30” is the second message in the mailbox.

The state illustrated in FIG. 4B corresponds to the transmission timing of a keep alive message (with the CANID of “1”). While the keep alive message transmission timing is reached (S106: YES), the mailbox is not empty (S109: NO). Thus, it then changes to the hold state where the destination to which a message is passed (stored) in the communication unit 13 is switched to the hold message queue. Hence, the passed keep alive message is stored at the head of the hold message queue.

The state illustrated in FIG. 4C corresponds to a transmission timing of another message in the hold state. The message to be passed to the mailbox in FIG. 4C is a message with the CANID of “40.” Since it is in the hold state, the message passed at step S104 is stored at the tail end of the hold message queue. Meanwhile, the message with the CANID of “5” is sent out to the communication bus 2 from the mailbox while the mailbox still includes the message with the CANID of “30” and is not empty (S113: NO), so that it remains in the hold state.

The state illustrated in FIG. 4D corresponds to a timing when the mailbox is emptied in the hold state. In FIG. 4D, since the message with the CANID of “30” having remained in the mailbox is sent out to the communication bus 2, it is determined that the mailbox is empty (S113: YES) in the hold state (S105: YES), and the messages stored in the hold message queue are stored in the mailbox in the same order as they are stored in the hold message queue. Thus, the keep alive message is next sent out to the communication bus 2.

As illustrated in FIG. 3 and FIGS. 4A-4D, the reason why the keep alive message is saved in the hold message queue at a timing when the keep alive message is to be transmitted is for preventing the keep alive message to which a higher priority is set from being sent out to the communication bus 2 prior to the target message that has already been stored in the mailbox. In the payload of the keep alive message, the number of transmissions of the target messages is stored. If a keep alive message is sent out prior to the target message, a discrepancy occurs between the stored number of transmissions and the number of actual transmissions, which may hamper an abnormality detection to be described below from being properly performed.

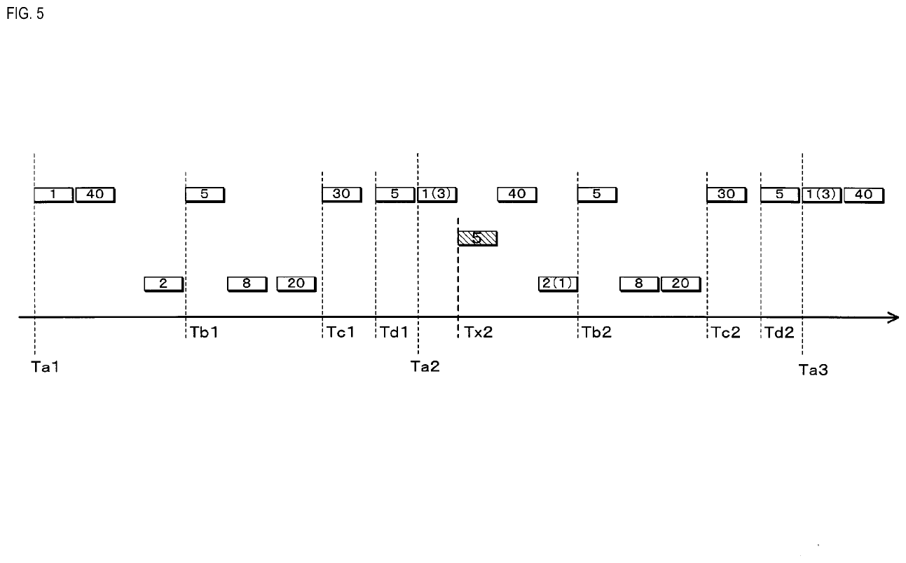

The processing of the flowchart in FIG. 3 and of the illustrative view in FIG. 4A to FIG. 4D is executed in each of the ECUs 1 to thereby allow another device to grasp the number of transmissions of the target messages that are sent out to the communication bus 2. FIG. 5 is a schematic view illustrating messages sent out to the communication bus 2. The horizontal axis in FIG. 5 represents the lapse of time while the rectangles in FIG. 5 represent CAN messages sent out to the communication bus 2 at the respective time points. Note that the number within the rectangle indicates the CANID.

In FIG. 5, the CAN messages with the CANID of “1” and “2” are keep alive messages. The bracketed figure in the rectangle representing the keep alive message indicates the number of transmissions included in the payload of the keep alive message. For example, the keep alive message with the CANID of “1” is transmitted from the ECU 1 from which messages with the CANID of “5” and “30” being the target messages and a message with the CANID of “40” other than the target message are transmitted. The keep alive message with the CANID of “2” is assumed to be transmitted from another ECU 1 from which a message with the CANID of “8” being the target message and a message with the CANID of “20” other than the target message are transmitted. In FIG. 5, the message with the CANID of “5” represented by hatching is assumed to be sent out to the communication bus 2 in an unauthorized manner. Note that, for facilitating the description in FIG. 5, depending on the difference in the ECUs 1 that transmit the messages, the positions of the rectangular boxes corresponding to the respective messages are shown at different levels, though all the messages are sent out to one communication bus 2 and are not discriminated from each other.

As illustrated in FIG. 5, each of the keep alive messages with the CANID of “1” transmitted at a time point Ta2 and a time point Ta3 includes the number of transmissions “3” of the target messages that have been sent out to the communication bus 2 after the preceding keep alive message is transmitted. The time period before the transmission of the keep alive message at the time point Ta2 is outside the monitoring period, and thus the keep alive message at the time point Ta1 does not include the number of transmissions of the target messages. Each of the ECUs 1 and the GW 3 that are connected to the communication bus 2 constantly monitor the communication bus 2 by the CAN transceiver. The messages with the CANID of “5” and “30” that are transmitted from the time point Ta1 to the time point Ta2 are received by each of the ECUs 1 and the GW3 at time points Tb1, Tc1 and Td1, that is, three times in total. Meanwhile, the messages with the CANID of “5” and “30” that are transmitted from the time point Ta2 to the time point Ta3 are received by each of the ECUs 1 and the GW3 at time points Tx2, Tb2, Tc2 and Td2, that is, four times in total.

This allows the ECU1 or the GW3 that receives messages from the communication bus 2 to detect abnormality by comparing the number of transmissions included in the keep alive message and the number of receptions.

In the present embodiment, the GW3 monitors the messages sent out to the communication bus 2 and detects an abnormality.

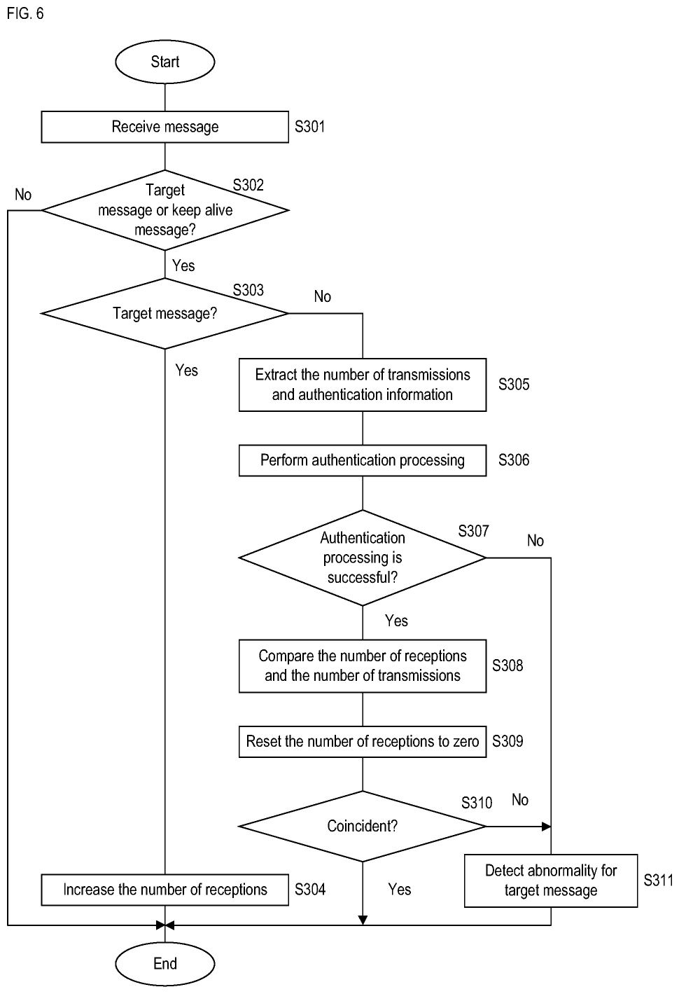

The details of the abnormality detection processing will be described with reference to a flowchart. FIG. 6 is a flowchart illustrating one example of message reception processing performed by the GW3 that detects an abnormality. As a communication processing unit, the control unit 30 repeatedly performs for each of the communication units 33 the processing of the flowchart illustrated in FIG. 6 on a message received from the communication unit 33 as well as performs normal relay processing. It is noted that the control unit 30 starts and repeatedly performs the processing if first receiving a keep alive message by the communication unit 33 of interest from any one of the ECUs 1 (if starting up from a sleep state), while the control unit 30 stops the processing if the ECU 1 being the transmission source of the target message is changed to the sleep state.

Every time the control unit 30 receives a message from the communication bus 2 by the communication unit 33 of interest (step S301), it determines whether the message is a target message to be counted or a keep alive message with reference to the CANID of the received message (step S302). If determining that the received message is the target message or the keep alive message (S302: YES), the control unit 30 determines whether the received message is the target message or not (step S303). If determining that the received message is the target message (S303: YES), the control unit 30 increases the number of receptions stored in the temporary storage unit 32 in association with the message received from the communication unit 33 (step S304) and ends the processing. The number of receptions is stored for each CANID group (corresponding keep alive messages) of the target messages. In the above-mentioned example, the number of receptions of the messages with the CANIDs “5” and “30” are stored in total. The control unit 30 then executes the processing from step S301 again.

If determining that the received message is the keep alive message at step S303 (S303: NO), the control unit 30 extracts the number of transmissions and the authentication information from the payload of the received message (step S305). The control unit 30 performs authentication processing using a key that is associated with the extracted authentication information in advance on the extracted authentication information (step S306). The control unit 30 determines whether or not the authentication processing is successful (step S307). If authentication is successful (S307: YES), the control unit 30 compares the number of receptions stored in association with the CANID of the received message and the number of transmissions extracted at step S305 (step S308) and resets the number of receptions to zero (step S309). In the present embodiment, the reset of the number of receptions is executed depending on the authentication result. The control unit 30 then determines whether or not the number of receptions is coincident with the number of transmissions as a result of the comparison at step S308 (step S310), and ends the processing if determining that they are coincident (S310: YES).

If determining that they are not coincident with each other at step S310 (S310: NO), the control unit 30 detects abnormality for the target message (step S311) and ends the processing.

If determining that the received message is a message other than the target message at step S302 (S302: NO), the control unit 30 ends the abnormality detection processing and starts the processing from step S101 in order to receive another message.

If determining that authentication is unsuccessful at step S307 (S307: NO), the control unit 30 detects abnormality (S31) and ends the processing. Here, since the keep alive message is not a safe massage, abnormality processing such as discarding such a message may be performed.

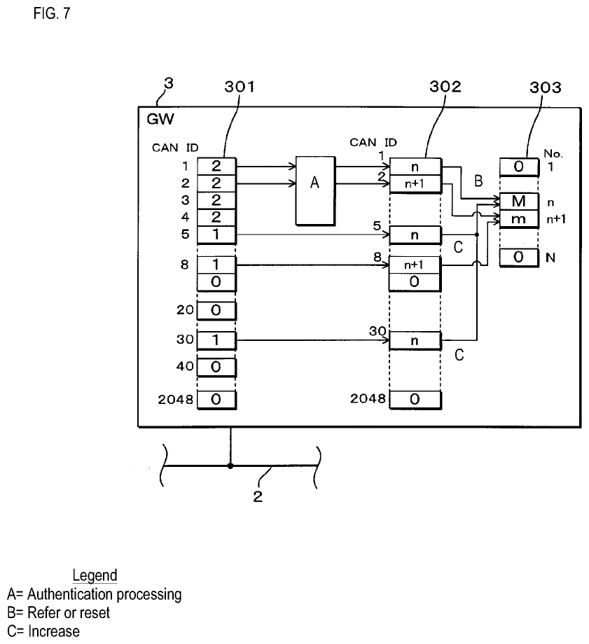

FIG. 7 illustrates the outline of the processing in the GW3.

The processing described using the flowchart in FIG. 6 will be described in detail with reference to FIG. 7.

The control unit 30 stores in the temporary storage unit 32 or the built-in memory for each of the multiple communication units 33 a first table 301 that stores a reference destination to be referred upon a transition to the abnormality detection processing for each CANID of the message received from the communication unit 33. In the first table 301 illustrated in FIG. 7, one of the respective numerals indicating that the message is a target message, that the message is a message other than the target message and the message is a keep alive message is stored for each CANID in an ascending order of the number of the CANID. In the example in FIG. 7, “2” indicative of the keep alive message is stored if the CANIDs are “1” to “4,” while “1” indicative of the target message is stored if the CANIDs are “5” and “30”. If “0” is obtained as a result of referring to the first table 301 based on the CANID of the received message, the control unit 30 determines that the received message is a message other than the target message at step S302 (S302: NO) while if “1” or “2” is obtained, the control unit 30 determines that the received message is the target message or the keep alive message at step S302 (S302: YES). Hence, the control unit 30 proceeds to the processing (S304 and S305) performed when the received message is the target message or the keep alive message based on the CANID of the received message.

The control unit 30 further stores in the temporary storage unit 32 or the built-in memory a second table 302 that stores for each of the multiple communication units 33 a reference destination for each CANID of the message received from the communication unit 33. In the second table 302 illustrated in FIG. 7, stored in an ascending order of the numbers of the CANIDs are numerals (numbers) indicating addresses in a third table 303 that stores the number of receptions of the target messages to be counted. The example in FIG. 7 shows that reference is to be made to the number of receptions in the “n”-th order in the third table 303 concerning the messages with the CANIDs of “5” and “30.” Also stored in the temporary storage unit 32 or the built-in memory is that reference is to be made to the number of receptions in the “n”-th order in the third table 303 concerning the keep alive message with the CANID of “1.” Stored is that reference is to be made to the number of receptions in the “n+1”-th order in the third table 303 concerning the target message with the CANID of “8.” Further stored is that reference is to be made to the number of receptions in the “n+1” -th order in the third table 303 concerning the keep alive message with the CANID of “2.”

As described above, the control unit 30 stores the third table 303 storing the number of receptions in the temporary storage unit 32 or the built-in memory. In the present embodiment, the number of transmissions included in the keep alive message is a numeral counted for each keep alive message (every ECU 1), and thus the third table 303 includes the number of receptions by the number of ECUs 1 of “N.” The control unit 30 performs increases the number of receptions, or refers to the number of receptions stored in the third table 303, or resets the number of receptions to zero. For example, if receiving the target messages with the CANID of “5” and “30” as described above, the control unit 30 increments the number of receptions at the “n-th” order by one in the third table 303 with reference to the second table 302 (S304). If receiving the keep alive message with the CANID of “1,” the control unit 30 refers to the number of receptions “M” at the “n-th” order in the third table 303 with reference to the second table 302 and compares “M” with the number of receptions in the message (S304).

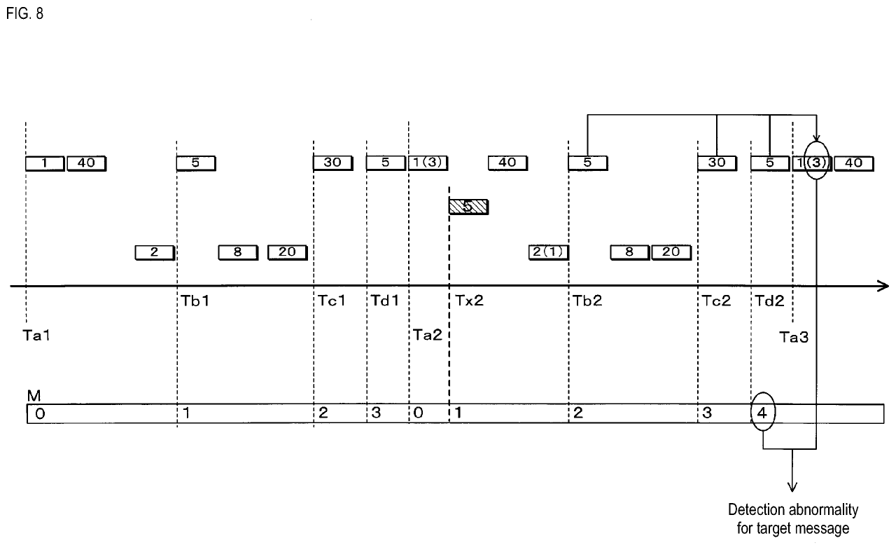

FIG. 8 illustrates the update of the number of receptions in the third table 303. FIG. 8 illustrates a time distribution of the messages illustrated in FIG. 5 at the upper part thereof and indicates the process of the updates of the number of receptions “M” in FIG. 7 in the respective time points at the lower part thereof. As illustrated in FIG. 8, the number of receptions “M” is increased at the time point Tx2 as well in the GW3, and the number of transmissions “3” included in the keep alive message with the CANID of “1” received at the time point Ta3 is compared with “4” at “M.” The keep alive message includes the authentication information in the payload for preventing alteration of the message, and thus the number of transmissions “3” included is reliable. Accordingly, the ECU 1 or the GW3 can find that any one of the target messages with the CANID of “5” and “30” received four times from the time point Tat to the time point Ta3 is a message transmitted in an unauthorized manner and is not reliable, that is, can detect abnormality (S311).

Hence, in the in-vehicle communication system 100 in the present disclosure, each of the ECUs 1 transmits a keep alive message periodically transmitted such that the number of transmissions of the messages to be monitored that are transmitted from itself is included. This allows the ECUs 1 including the ECU 1 itself and the GW3 to detect the transmission of an unauthorized message without adding authentication information to the messages other than the keep alive messages. It is noted that an important message transmitted from the ECU 1 may further include authentication information in the message itself. This makes it possible to more strictly protect the network by using the abnormality detection by the number of transmissions authenticated by the keep alive message and the authentication of the message itself.

In the present embodiment, the number of transmissions included in the payload of the keep alive message corresponds to the total number of transmissions of the messages to be counted (the total numbers of transmissions of the messages with the CANIDs of “5” and “30,” for example), though the number of transmissions for each CANID may be employed. In this case, for example, one byte is used for the number of transmissions, and the former four bits may be specified to represent the number of transmissions of the messages with the CANID of “5” while the latter four bits may be specified to represent the number of transmissions of the messages with the CANID of “30.” In some embodiments, information indicating an error state (error active or error passive) of the ECU 1 may be included in the keep alive message transmitted from each of the ECUs 1. Out of 6 bytes to be used for user data in the payload of the keep alive message in the AUTOSAR, 4 bytes, for example, may be used for authentication information (MAC), and the rest of 16 bits may be specified to represent the number of transmissions and the error state. In the present embodiment, communication complying with the CAN is performed. This makes it possible to inform another device of an error state by using a keep alive message without an extension to the CAN FD. Here, when the abnormality detection processing at step S311 in the flowchart illustrated in FIG. 6 is performed, abnormality can be detected in view of the error state of the ECU 1 that transmits the keep alive message.

In the present embodiment, the CANID of the keep alive message is set to have a higher priority such that the transmission of the keep alive message is prioritized upon arbitration of the communication bus 2, though the setting of the CANID of the keep alive message is not limited to the above-description. If the decided number of transmissions can be included in the keep alive message at a timing when the keep alive message is capable of being sent out to the communication bus 2, the keep alive message needs not be set to have a higher priority than other messages. In an embodiment where the transmission timing of the keep alive message is set to have a higher priority, the transmission timing of the keep alive message may appropriately be designed so as not to hinder transmission and reception of other messages. The transmission timing is every preset time, though the transmission timing is not limited to be periodic. In some embodiments, when a next keep alive message is actually sent out to the communication bus 2 after one keep alive message was sent out to the communication bus 2, the number of transmissions of the target messages that are transmitted between these timings may surely be included.

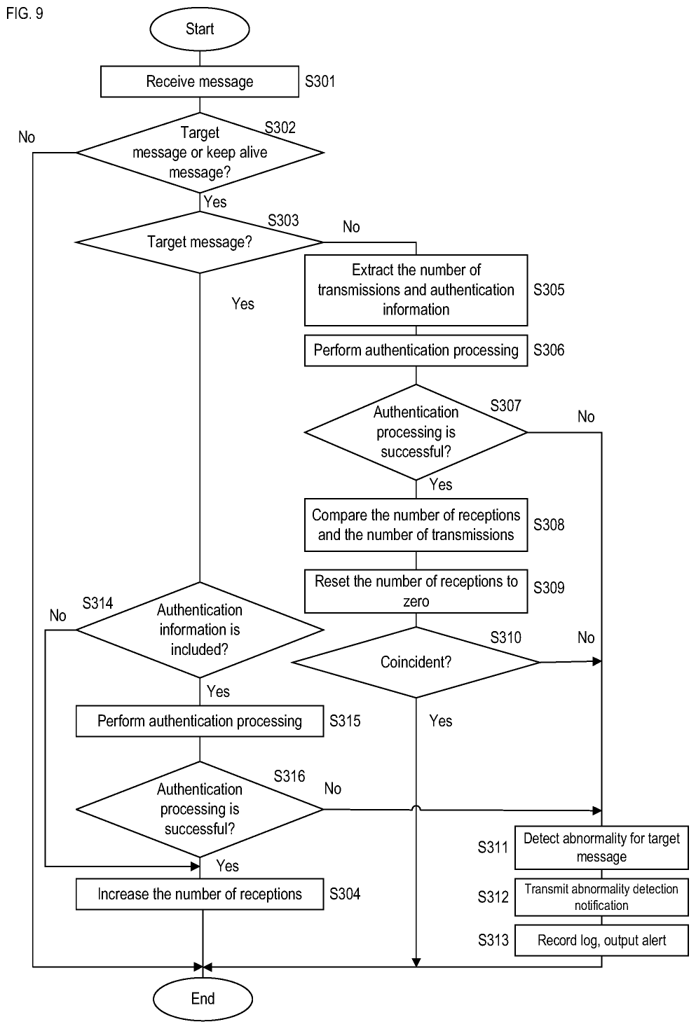

Described next is processing in the case where an abnormality is detected, that is, in the case where the presence of an authorized message is found in the messages transmitted to the communication bus 2. FIG. 9 is a flowchart of one example of a processing procedure relating to abnormality detection. In the flowchart illustrated in FIG. 9, steps common to the processing procedure of the flowchart illustrated in FIG. 6 are denoted by the same step numbers and the detailed description thereof will not be repeated.

When detecting an abnormality at step S311, the control unit 30 transmits an abnormality detection notification including information for identifying the CAN ID of the keep alive message received at step S301 to the communication bus 2 (step S312). The control unit 30 records the detected abnormality in a log, outputs an alert (step S313) and ends the processing. Note that the alert may be output as necessary on an in-vehicle display or be output as an alert sound directed for the driver of the vehicle mounted with the in-vehicle communication system 100. Moreover, the alert may be output to an automaker, a dealer or a security company via another in-vehicle device including a wireless communication device.

By the abnormality detection notification at step S312, the ECU 1 having received the notification and determined that the notification includes the CANID of the keep alive message transmitted by itself adds authentication information to a part or all of the target messages to be counted thereafter, similarly to the keep alive message. Here, it is more preferable to restrictively add the authentication information to only the messages with higher priorities including information to be protected, not all the messages to be monitored.

In response thereto, the control unit 30 determines whether or not authentication information is included (step S314) in the case where the received message is determined to be the target message as well (S303: YES). If determining that the authentication information is included (S314: YES), the control unit 30 executes the authentication processing (step S315) and then advances the processing. Here, the control unit 30 determines whether or not authentication processing is successful (step S316). If determining that the authentication processing is successful (S316: YES), or determining that the authentication information is not included (S314: NO), the control unit 30 increases the number of receptions (S304). If determining that the authentication processing is unsuccessful (S316: NO), the control unit 30 may advance the abnormality detection processing (S311). This enables continuous operation of the system by removing an unauthorized message in the case where an abnormality is detected.

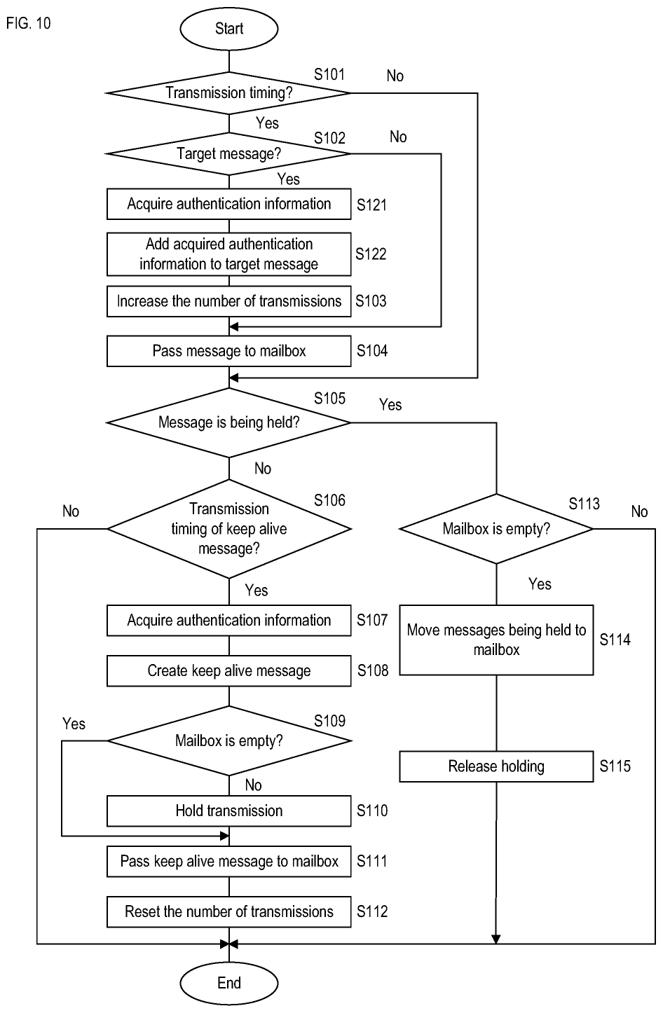

FIG. 10 is a flowchart illustrating one example of the processing procedure in the ECU 1 after abnormality detection.

In the flowchart illustrated in FIG. 10, steps common to the processing procedure of the flowchart illustrated in FIG. 3 are denoted by the same step numbers and the detailed description thereof will not be repeated. If determining that the message to be transmitted is the target message (S102: YES), the control unit 10 acquires authentication information (step S121), adds the acquired authentication information to the target message (step S122) and increases the number of transmissions (S103).

Hence, if an abnormality is detected, authentication information is added restrictively to the target message to be transmitted thereafter as well as the abnormality is notified to the driver, whereby it is possible to reinforce the protection of the network by the abnormality detection based on the number of transmissions authorized by the keep alive message as well as the authentication of the message itself. Alternatively, the ECU 1 having received an abnormality notification may stop the transmission if detecting an abnormality for the target message to be transmitted by the ECU 1 itself.

Alternatively, taking abnormality detection as a trigger, a measure may be taken of disconnecting the communication bus 2 through which an unauthorized message is transmitted. For example, in the case where a redundant network is configured where the ECUs 1 are connected to another CAN bus serving as a subnetwork as well as the communication bus 2, the operation of the network can be continued even after the communication bus 2 is disconnected taking the abnormality detection as a trigger.

The abnormality detection processing in the present embodiment is executed by the GW3, though it may be executed by another ECU1 or a special in-vehicle communication device connected to the communication bus 2.

In addition, in the present embodiment, various programs such as the abnormality detection program 3P, the control program, etc. executed by the control unit 30 of the GW3 may be recorded and provided in a computer-readable manner onto a recording medium such as an optical disk, a memory card, or the like.

What is claimed is:

1. An in-vehicle communication device including a communication unit being bus-connected to an in-vehicle communication bus, comprising:
a communication control unit that controls transmission and reception of a message including a target message to be counted, by the communication unit, and intermittently transmits a specific message including authentication information from the communication unit, wherein
the communication control unit is adapted to include in the specific message to be transmitted at a first time point the number of transmissions of the target messages that have been transmitted during a period from transmission of a latest specific message transmitted before the first time point to the first time point.

2. The in-vehicle communication device according to claim 1, wherein
the in-vehicle communication bus is a CAN bus, and
the specific message is a keep alive message periodically transmitted, and in a payload of the keep alive message, the authentication information and the number of transmissions are included, and the keep alive message is provided with an CANID having a priority over another communication device upon arbitration of the CAN bus.

3. The in-vehicle communication device according to claim 2, wherein the specific message includes information indicating an error state of the in-vehicle communication device.

4. An in-vehicle communication device including a communication unit being bus-connected to an in-vehicle communication bus, and transmitting and receiving a message by the communication unit, comprising:
a storage unit that stores the number of receptions of target messages to be counted;
an update unit that updates the number of receptions stored in the storage unit if the message received by the communication unit is one of the target messages; and
an abnormality detection unit that, if the message received by the communication unit is a specific message, reads out the number of receptions stored in the storage unit, determines whether or not the number of receptions is coincident with the number of transmissions of the target messages included in the specific message, and detects an abnormality if it is determined that the number of receptions and the number of transmissions are not coincident with each other.

5. The in-vehicle communication device according to claim 4, wherein the abnormality detection unit
further comprises an authentication processing unit that executes authentication processing based on authentication information included in the specific message, and
detects normality if it is determined that authentication by the authentication processing unit is successful, and the number of receptions is coincident with the number of transmissions.

6. An in-vehicle communication system comprising a plurality of in-vehicle communication devices each including a communication unit being bus-connected to an in-vehicle communication bus, wherein
a part of the plurality of in-vehicle communication devices
includes a communication control unit that controls transmission and reception of a message including a target message to be counted, by the communication unit, and intermittently transmits a specific message including authentication information from the communication unit, wherein
the communication control unit is adapted to include in the specific message to be transmitted at a first time point the number of transmissions of the target messages that have been transmitted during a period from transmission of a latest specific message transmitted before the first time point to the first time point,
a part or all of the plurality of in-vehicle communication devices include
a storage unit that stores the number of receptions of the target messages,
an update unit that updates the number of receptions stored in the storage unit if the message received by the communication unit is the target message, and
an abnormality detection unit that, if the message received by the communication unit is the specific message, reads out the number of receptions stored in the storage unit, determines whether or not the number of receptions is coincident with the number of transmissions of the target messages included in the specific message, and detects an abnormality if the number of receptions and the number of transmissions are not coincident with each other.

7. An in-vehicle communication method of transmitting and receiving a message between a plurality of in-vehicle communication devices each including a communication unit being bus-connected to an in-vehicle communication bus, comprising:
by a part of the plurality of in-vehicle communication devices,
transmitting a plurality of times a message including a target message to be counted from the communication unit;
intermittently transmitting a specific message including authentication information from the communication unit; and
including in the specific message to be transmitted at a first time point the number of transmissions of the target messages that have been transmitted during a period from transmission of the latest specific message transmitted before the first time point to the first time point,
the method further comprising:
by a part or all of the plurality of in-vehicle communication devices;
updating the number of receptions stored in a storage unit if the message received by the communication unit is the target message;
reading out the number of receptions stored in the storage unit if the message received by the communication unit is the specific message;
determining whether or not the number of receptions is coincident with the number of transmissions of the target messages included in the specific message received; and
detecting an abnormality if the number of receptions is not coincident with the number of transmissions.
